(19) United States
(12) Patent Application Publication
(10) Pub. No.: US 2005/0061921 A1
(43) Pub. Date: Mar. 24, 2005

(54) Aerodynamic tip protuberances for tip vortex intensity reduction

(76) Inventor: Thomas A. Egolf, Glastonbury, CT (US)

Correspondence Address: CARLSON, GASKEY & OLDS, P.C., 400 WEST MAPLE ROAD, SUITE 350, BIRMINGHAM, MI, 48009, US

(21) Appl. No.: 10/666,166

(22) Filed: Sep. 19, 2003

(51) Int. Cl. B64C 23/06

(52) U.S. Cl. 244/199

(57) ABSTRACT

A vortex generator includes a multiple of vorticity generating protuberances that produce small-scale vortices that are entrained within a primary tip vortex. The small-scale vortices causes the primary tip vortex to diffuse and dissipate at a rate greater than what normally occurs, thereby reducing the intensity of the primary tip vortex.

### BACKGROUND OF THE INVENTION

The present invention relates to aerodynamic structures, and more particularly to protuberances on a tip of an aerodynamic structure to produce small-scale vortices that are entrained within the tip vortex thereby reducing the intensity thereof.

Aerodynamic surfaces produce tip vortices as an artifact of flow. For example, during typical rotorcraft flight operations, rotor blades of a main rotor assembly, due to the airfoil profile and angle of attack of the rotor blades, create a high velocity low pressure field over the upper aerodynamic surface of each rotor blade and a low velocity high pressure field over the lower aerodynamic surface of each rotor blade. At the tip of each rotor blade this pressure differential effectively engenders airflow circulation from the high pressure field to the low pressure field to create a tip vortex.

For rotorcraft flight operations, a significant noise level is radiated during maneuvers and low speed, descending flight profiles. The tip vortex is shed from the rotor blade and collides with a trailing rotor blade during a low speed, descending flight profile. The collision of the tip vortex with the trailing rotor blade induces impulsive airloading against the trailing rotor blade, creating acoustic pressure waves that are the source of blade-vortex interaction (BVI) noise. The BVI noise signature of a rotorcraft is directly related to the magnitude of the peak-to-peak velocity across the core and the size of the core of the generated tip vortex.

The tip vortex shed by each rotor blade may also impinge upon other rotor blades, fuselage sections downstream of the main rotor assembly, empennage, and/or the tail rotor blades. The impingement of the tip vortices with any of these structural elements induces vibrations therein, thereby increasing the overall vibration level of the rotorcraft.

Accordingly, it is desirable to provide an airfoil tip configuration that reduces the peak to peak velocity and increases the core size of the generated tip vortex.

### SUMMARY OF THE INVENTION

The vortex generator according to the present invention includes a multiple of vorticity generating protuberances. The vorticity generating protuberances produce small-scale vortices that are entrained within a primary tip vortex generated by a tip of an aerodynamic member such as a rotor blade or wing. The small-scale vortices causes the primary tip vortex to diffuse and dissipate at a rate greater than what normally occurs, thereby reducing the intensity of the primary tip vortex. In other words, the small-scale vortices destabilize the core of the primary tip vortex and accelerates its diffusion.

The present invention therefore provide an airfoil tip configuration that reduces the peak to peak velocity and increases the core size of the of the generated tip vortex.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 is a general perspective view an exemplary rotary wing aircraft embodiment for use with the present invention;

FIG. 2 is a plan view of a rotor blade for use with the present invention;

FIG. 3 is an expanded view of a multiple of selectively deployable vorticity generating protuberances;

FIG. 4 is an expanded view of a multiple of fixed vorticity generating protuberances extending from a rotor blade;

FIG. 5 is an expanded view of a multiple of selectively deployable vorticity generating protuberances extending from another fixed aerodynamic structure;

FIG. 6 is an expanded view of a multiple of selectively deployable vorticity generating protuberances extending from another fixed aerodynamic structure; and

FIG. 7 is an expanded view of a multiple of selectively deployable vorticity generating protuberances extending from a rotating aerodynamic structure.

### DETAILED DESCRIPTION OF THE PREFERRED EMBODIMENT

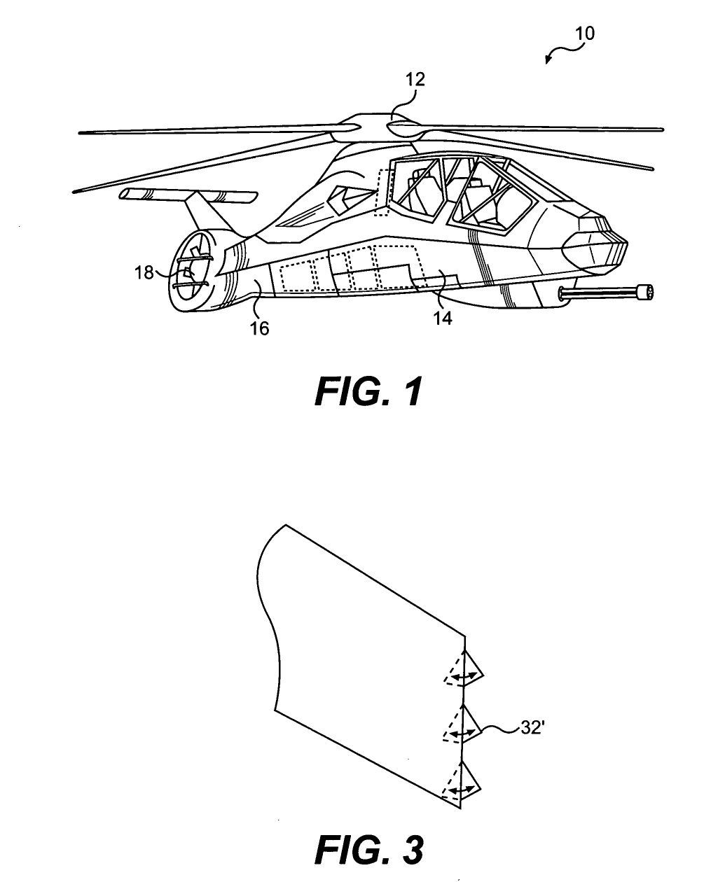

FIG. 1 schematically illustrates a rotary wing aircraft 10 having a main rotor assembly 12. The aircraft 10 includes an airframe 14 having an extending tail 16 which mounts an anti-torque rotor 18. Although a particular helicopter configuration is illustrated in the disclosed embodiment, other machines such as turbo-props and tilt-wing aircraft will also benefit from the present invention.

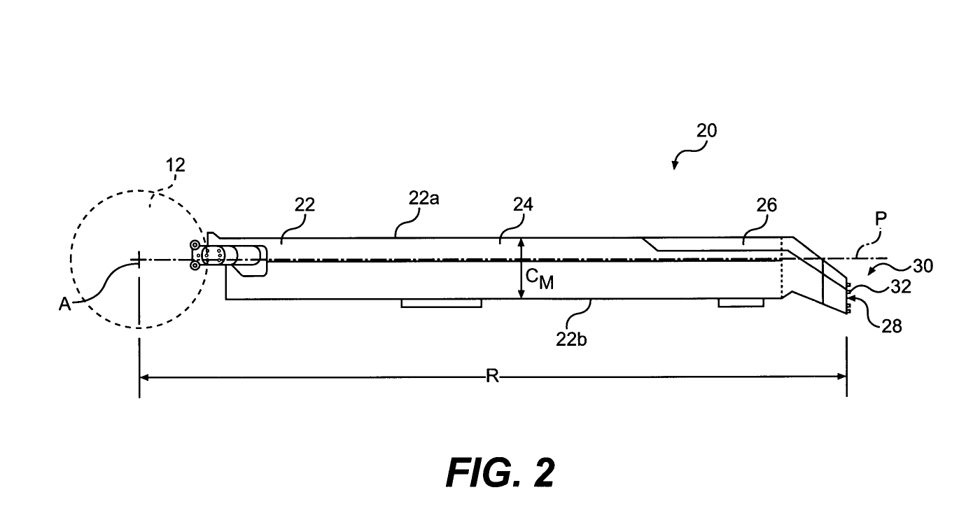

Referring to FIG. 2, a rotor blade 20 (only one illustrated) of the rotor assembly 12 includes an inboard section 22, an intermediate section 24, and an outboard section 26. The inboard, intermediate, and outboard sections 22, 24, 26 define the span of the main rotor blade 20. The blade sections 22, 24, 26 define a blade radius R between the axis of rotation A and a blade tip 28.

The blade root portion 22 is attached to a rotor assembly (FIG. 1) for rotating the rotor blade 20 about the axis of rotation A. The main element 22 defines a leading edge 22a and a trailing edge 22b, which are generally parallel to each other. The distance between the leading edge 22a and the trailing edge 22b defines a main element chord length Cm.

A vortex generator 30 is located adjacent the blade tip 28. The vortex generator preferably includes a multiple of vorticity generating protuberances 32. The vorticity generating protuberances 32′ are alternatively or additionally selectively deployable (FIG. 3). That is, the vorticity generating protuberances 32′ may alternatively or additionally be actively deployable related to the azimuth position.

While the vortex generator 30 according to the present invention is described herein in terms of the main rotor blades of a helicopter main rotor assembly, one skilled in the art will appreciate that the vortex generator 10 will have utility for other rotating aerodynamic structures such as tail blades, windmills, propellers, rotors, turbines, tilt rotor props and fixed aerodynamic structures such as wings, fins, and sails among others.

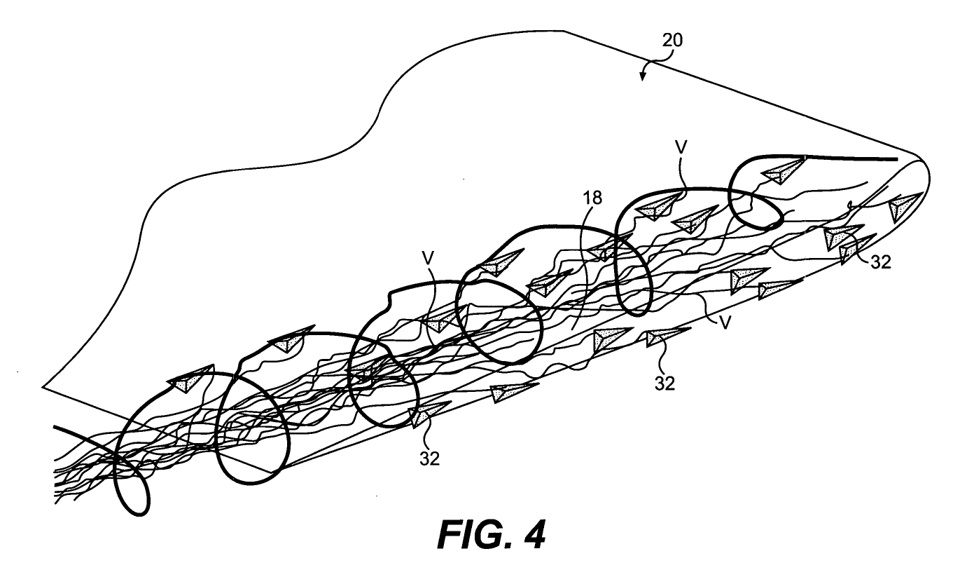

Referring to FIG. 4, the blade tip 18 generates a primary tip vortex V. The vorticity generating protuberances 32 produce small-scale vortices v that are entrained within the primary tip vortex V. The small-scale vortices v causes the primary tip vortex V to diffuse and dissipate at a rate greater than what normally occurs, thereby reducing the intensity of the primary tip vortex V. In other words, the small-scale vortices v destabilize the core of the primary tip vortex V and accelerates its diffusion.

Preferably, the scale of the vorticity generating protuberances 32 will nominally be such that the small-scale vortices v produced are smaller than the primary tip vortex V. It should be understood that the details of size, shape, location, and number of the protuberances will vary depending on the details of the forming tip vortex they are intended to affect and the desired impact. Such vorticity generating protuberances 32 such as pins, vanes, reward and forward facing vortex plows, ramps, and or other such members are representative of protuberances 32 which will benefit from the present invention

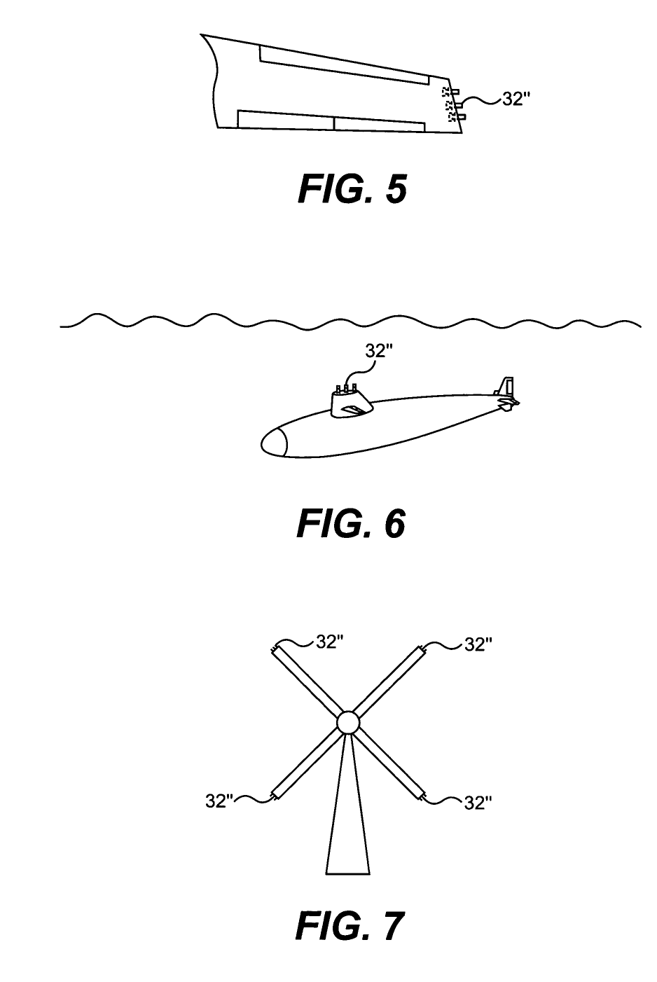

The vorticity generating protuberances 32″ will likewise benefit fixed structures such as a wing (FIG. 5) a submarine sail (FIG. 6) as well as other rotating aerodynamic structures such as windmill blades (FIG. 7).

Although particular step sequences are shown, described, and claimed, it should be understood that steps may be performed in any order, separated or combined unless otherwise indicated and will still benefit from the present invention.

The foregoing description is exemplary rather than defined by the limitations within. Many modifications and variations of the present invention are possible in light of the above teachings. The preferred embodiments of this invention have been disclosed, however, one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

1. A vortex generator for a surface which generates a primary tip vortex, said vortex generator comprising:
a plurality of vorticity generating protuberances defined upon a distal end of a tip defined between an upper and lower aerodynamic surface to generate small-scale vortices that are ingested and at least partially entrained within a forming core of the primary tip vortex as the primary tip vortex develops from the tip such that a decay rate of the core is accelerated.

2. (CANCELED)

3. The vortex generator as recited in claim 1, wherein said surface comprises a rotating aerodynamic surface, said plurality of vorticity generating protuberances located generally parallel to a feathering axis.

4. The vortex generator as recited in claim 1, wherein said surface comprises a rotor blade, said plurality of vorticity generating protuberances located generally parallel to a feathering axis.

5. The vortex generator as recited in claim 1, wherein said plurality of vorticity generating protuberances comprise deployable members.

6. (CANCELED)

7. An aerodynamic member comprising:
an outboard section terminating in a tip which generates a primary tip vortex, said outboard section defining a longitudinal axis; and
a plurality of vorticity generating protuberances which extend from a distal end of said tip generally parallel to the longitudinal axis, said plurality of vorticity generating protuberances generate small-scale vortices that are ingested and at least partially entrained within a forming core of the primary tip vortex as the primary tip vortex develops from the tip such that a decay rate of the core is accelerated.

8. The aerodynamic member as recited in claim 7, wherein said distal end is a distal end of a rotor blade, said longitudinal axis comprising a feathering axis.

9. The aerodynamic member as recited in claim 7, wherein said distal end is a distal end of a wing.

10. The aerodynamic member as recited in claim 7, wherein said tip comprises a distal end of a propeller, said longitudinal axis comprising a feathering axis.

11. A method of accelerating diffusion of a primary tip vortex comprising the step of:
(1) generating small-scale vortices from a distal end of a surface that are ingested and at least partially entrained within a forming core of the primary tip vortex as the primary tip vortex develops from the tip to destabilize the core of the primary tip vortex such that a decay rate of the core is accelerated.

12. A method as recited in claim 11, wherein step (1) further comprises locating a plurality of vorticity generating protuberances on a tip of a rotating member which generates the primary tip vortex.

13. A method as recited in claim 11, wherein step (1) further comprises locating a plurality of vorticity generating protuberances on a tip of a fixed member which generates the primary tip vortex.

14. A method as recited in claim 11, further comprising the step of:
selectively extending a vorticity generating protuberances from a tip which generates the primary tip vortex.

15-17. (CANCELED)

18. The aerodynamic member as recited in claim 7, wherein said tip is defined between an upper and lower aerodynamic surface, said longitudinal axis comprising a feathering axis.

19. A method as recited in claim 11, further comprising the step of:
selectively extending a vorticity generating protuberance from a tip of a rotor blade which generates the primary tip vortex in response to an azimuthally position of the rotor blade.

20. A method as recited in claim 11, wherein step (1) further comprises locating a plurality of vorticity generating protuberances on a distal end between an upper and lower aerodynamic surface of a tip which generates the primary tip vortex.

21. The vortex generator as recited in claim 1, wherein said plurality of vorticity generating protuberances are of a scale commensurate to a boundary layer thickness.

22. The vortex generator as recited in claim 1, wherein said plurality of vorticity generating protuberances include a multiple of pins.

23. The vortex generator as recited in claim 1, wherein said plurality of vorticity generating protuberances include a multiple of vortex plows.

24. The vortex generator as recited in claim 1, wherein said plurality of vorticity generating protuberances include a multiple of vortex ramps.

25. A method as recited in claim 11, wherein step (1) further comprises maintaining the primary tip vortex as a single vortex with the core being increasing diffused downstream of the tip.

26. A method as recited in claim 11, wherein step (1) further comprises generating the small-scale vortices from within the core of the primary tip vortex.

27. A method of accelerating diffusion of a primary tip vortex comprising the step of:
(1) generating a single primary tip vortex from a distal end of a rotary aerodynamic surface;
(2) generating small-scale vortices from a distal end of the aerodynamic surface that are ingested and at least partially entrained within a forming core of the single primary tip vortex as the primary tip vortex develops from the tip;
(3) maintaining the single primary tip vortex while accelerating a decay rate of the core by the ingested small-scale vortices generated in said step (2).
